(19) United States
(12) Patent Application Publication
(10) Pub. No.: US 2024/0037376 A1
(43) Pub. Date: Feb. 1, 2024

(54) SIGNAL PROCESSING APPARATUS FOR REDUCING AMOUNT OF MID-COMPUTATION DATA TO BE STORED, METHOD OF CONTROLLING THE SAME, AND STORAGE MEDIUM

(71) Applicant: CANON KABUSHIKI KAISHA, Tokyo (JP)

(72) Inventors: Hayato OURA, Tokyo (JP); Takayuki KOMATSU, Kanagawa (JP); Takaaki YOKOI, Kanagawa (JP)

(21) Appl. No.: 18/353,911

(22) Filed: Jul. 18, 2023

(30) Foreign Application Priority Data
Jul. 29, 2022 (JP) 2022-122014

(51) Int. Cl. G06N 3/0464

(52) U.S. Cl. CPC G06N 3/0464

(57) ABSTRACT

A signal processing apparatus executes a convolution operation of predetermined layers constituting a neural network; and transfers first form data to be stored in a storage. The apparatus executes, on output data outputted from a convolution operation of a first layer among the predetermined layers, an arithmetic operation of a compression layer that is configured by a neural network and compresses data, and outputs the first form data to be transmitted to the storage. The apparatus further executes, on the first form data stored in the storage, an arithmetic operation of a restoration layer that is configured by a neural network and restores pre-compression data, and outputs input data to be inputted to a convolution operation of a second layer among the predetermined layers.

### BACKGROUND OF THE INVENTION

### Field of the Invention

The present invention relates to a signal processing apparatus for reducing the amount of mid-computation data to be stored, a method of controlling the same, and a storage medium.

### Description of the Related Art

In recent years, a technique for applying a convolutional neural network (CNN) to data, such as an image, has been known. With an increase in the scale of neural networks, the amount of mid-computation data is on an increasing trend. When the amount of mid-computation data increases, a bandwidth necessary between a computation unit for performing computations of a neural network and a storage unit for storing mid-computation data also increases in an edge device. Therefore, a technique for reducing a necessary bandwidth by compressing and restoring mid-computation data of a neural network has been proposed (Japanese Patent Laid-Open No. 2020-517014).

This prior art attempts to reduce a memory bus bandwidth by truncating low-order bits of non-zero bytes of uncompressed activation data such that the non-zero byte data fits in the number of available bits. When data is compressed with such a method, information is lost; therefore, the accuracy of a result of a neural network-based operation may deteriorate. In addition, the compression method described in the prior art is a rule-based method; therefore, due to its mechanism, there is no room for prevention of accuracy deterioration (of a result of a neural network-based operation) caused by compression and restoration so long as the same method is used.

### SUMMARY OF THE INVENTION

The present invention has been made in view of the aforementioned problems. The purpose thereof is to realize a technique for providing a mechanism capable of preventing accuracy deterioration caused by compression and restoration of a result of computation of a neural network by training and for allowing reduction of a bandwidth necessary for storing data in the middle of computation of a neural network.

In order to solve the aforementioned issues, one aspect of the present disclosure provides a signal processing apparatus comprising: one or more processors; and a memory storing instructions which, when the instructions are executed by the one or more processors, cause the signal processing apparatus to function as: a processing unit configured to execute a convolution operation of predetermined layers constituting a neural network; and a transfer unit connected with the processing unit and configured to transfer first form data to be stored in a storage unit, wherein the processing unit further executes, on output data outputted from a convolution operation of a first layer among the predetermined layers, an arithmetic operation of a compression layer that is configured by a neural network and compresses data, and outputs the first form data to be transmitted to the storage unit, and executes, on the first form data stored in the storage unit, an arithmetic operation of a restoration layer that is configured by a neural network and restores pre-compression data, and outputs input data to be inputted to a convolution operation of a second layer among the predetermined layers.

Another aspect of the present disclosure provides a method of controlling a signal processing apparatus, the method comprising: executing a convolution operation of predetermined layers constituting a neural network; and transferring first form data to be stored in a storage unit, wherein in the executing, an arithmetic operation of a compression layer that is configured by a neural network and compresses data is further executed on output data outputted from a convolution operation of a first layer among the predetermined layers, and the first form data to be transmitted to the storage unit is outputted, and an arithmetic operation of a restoration layer that is configured by a neural network and restores pre-compression data is executed on the first form data stored in the storage unit, and input data to be inputted to a convolution operation of a second layer among the predetermined layers is outputted.

Still another aspect of the present disclosure provides a non-transitory computer-readable storage medium comprising instructions for performing a method of controlling a signal processing apparatus, the method comprising: executing a convolution operation of predetermined layers constituting a neural network; and transferring first form data to be stored in a storage unit, wherein in the executing, an arithmetic operation of a compression layer that is configured by a neural network and compresses data is executed on output data outputted from a convolution operation of a first layer among the predetermined layers, and the first form data to be transmitted to the storage unit is outputted, and an arithmetic operation of a restoration layer that is configured by a neural network and restores pre-compression data is executed on the first form data stored in the storage unit, and input data to be inputted to a convolution operation of a second layer among the predetermined layers is outputted.

According to the present invention, it is possible to provide a mechanism capable of preventing, by training, accuracy deterioration caused by compression and restoration of a result of computation of a neural network and reduce a bandwidth necessary for storing data in the middle of computation of a neural network.

Further features of the present invention will become apparent from the following description of exemplary embodiments (with reference to the attached drawings).

### BRIEF DESCRIPTION OF THE DRAWINGS

FIG. 1 is a block diagram illustrating an example of a functional configuration of a signal processing apparatus according to a first embodiment.

FIGS. 2A and 2B are diagrams illustrating an input/output relationship between CNNs according to the first embodiment.

FIGS. 3A and 3B are diagrams illustrating transfer data according to the first embodiment.

FIG. 4 is a diagram illustrating training of a compression layer and a restoration layer according to the first embodiment.

FIG. 5 is a flowchart for explaining transfer data conversion processing according to the first embodiment.

FIG. 6 is a diagram illustrating training of compression layers and restoration layers according to a second embodiment.

FIG. 7 is a block diagram illustrating an example of a functional configuration of a signal processing system according to a third embodiment.

FIG. 8 is a flowchart for explaining transfer data conversion processing according to the third embodiment.

FIG. 9 is a block diagram illustrating an example of a functional configuration of the signal processing apparatus according to a fourth embodiment.

FIG. 10 is a flowchart illustrating transfer data conversion processing according to the fourth embodiment.

FIG. 11 is a block diagram illustrating an example of a functional configuration of the signal processing apparatus according to a fifth embodiment.

FIG. 12 is a flowchart for explaining transfer data conversion processing according to the fifth embodiment.

FIG. 13 is a block diagram illustrating an example of a functional configuration of the signal processing apparatus according to a sixth embodiment.

FIGS. 14AA and 14AB are diagrams (1) for explaining a compression layer and a restoration layer according to the sixth embodiment.

FIGS. 14BA and 14BB are diagrams (2) for explaining a compression layer and a restoration layer according to the sixth embodiment.

FIG. 15 is a flowchart for explaining transfer data processing according to the sixth embodiment.

### DESCRIPTION OF THE EMBODIMENTS

### First Embodiment

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

In the following, an example in which a digital camera capable of reducing a bandwidth of data to be transferred to a memory is used as one example of a signal processing apparatus will be described. However, the present embodiment is not limited to the example of a digital camera and is also applicable to other devices capable of reducing a bandwidth of data to be transferred to a memory. These devices may include, for example, a personal computer, a smartphone, a game machine, a tablet terminal, a display apparatus, a medical device, and the like.

One or more functional blocks to be described below may be realized by hardware, such as an ASIC, or may be realized by a programmable processor, such as a CPU or a GPU, executing software. They may also be realized by a combination of software and hardware. In addition, those described to be a single functional block in the following description may function as a plurality of functional blocks and those described to be a plurality of functional blocks in the following description may function as a single functional block.

<Configuration of Signal Processing Apparatus 100>

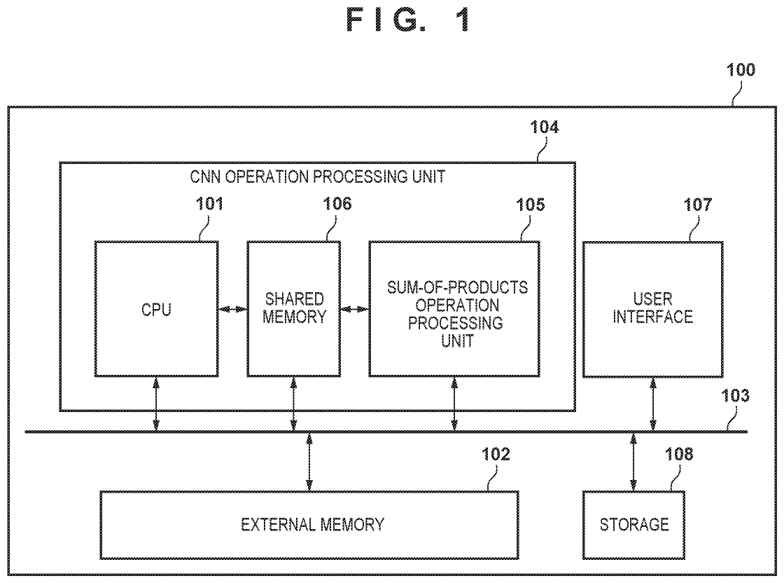

An example of a functional configuration of a signal processing apparatus 100 will be described with reference to FIG. 1. As illustrated in FIG. 1, the signal processing apparatus 100 includes an external memory 102, an internal bus 103, a CNN operation processing unit 104, a user interface 107, and a storage 108. The CNN operation processing unit 104 includes a CPU 101, a sum-of-products operation processing unit 105, and a shared memory 106.

The CPU 101 may include one or more processors and can function as a controller for controlling the operation of the signal processing apparatus 100. The CPU 101, for example, controls the operation of each unit in the signal processing apparatus 100 by executing a program stored in the storage 108. In FIG. 1, description will be given using an example in which the CPU 101 is included in the CNN operation processing unit 104; however, the CPU 101 need not to be included in the CNN operation processing unit 104.

The external memory 102 includes a storage medium, such as a volatile memory, and is generally a low-speed, high-capacity memory relative to the shared memory 106. The external memory 102 stores image data to be a target of processing by the CNN operation processing unit 104, processed data, or CNN model parameters (e.g., weight parameters between respective neurons). The internal bus 103 is connected to the respective units of the signal processing apparatus, such as the CPU 101, the external memory 102, the sum-of-products operation processing unit 105, and the shared memory 106, and communicates data based on a predetermined communication protocol. For example, the internal bus transfers later-described transfer data to be stored in the external memory 102.

As a central CNN operation processor, the sum-of-products operation processing unit 105 repeatedly performs a sum-of-products operation of a CNN. The sum-of-products operation processing unit 105 may include, for example, a graphics processing unit (GPU). The shared memory 106 includes a storage medium, such as a volatile memory, and can store a result of computation of the sum-of-products operation processing unit 105, parameters of a model used for a sum-of-products operation, and the like. The shared memory 106 can be accessed from the CPU 101 and the sum-of-products operation processing unit 105 as well as the internal bus 103.

The user interface 107 receives user operations of the signal processing apparatus 100 and stores various setting values set by the operations in the external memory 102 or the shared memory 106. The stored various setting values are read out by the CPU 101 as setting values. The storage 108 may include a non-volatile storage medium, such as an SSD, and stores programs to be executed by the CPU 101 and the sum-of-products operation processing unit 105.

In the following description, description will be given using as an example a case where data to be a target of processing by the signal processing apparatus 100 is an image, which is a typical CNN processing target; however, the present embodiment is also applicable to a case where the processing target data is other data that is not an image.

<Overview of CNN Operation>

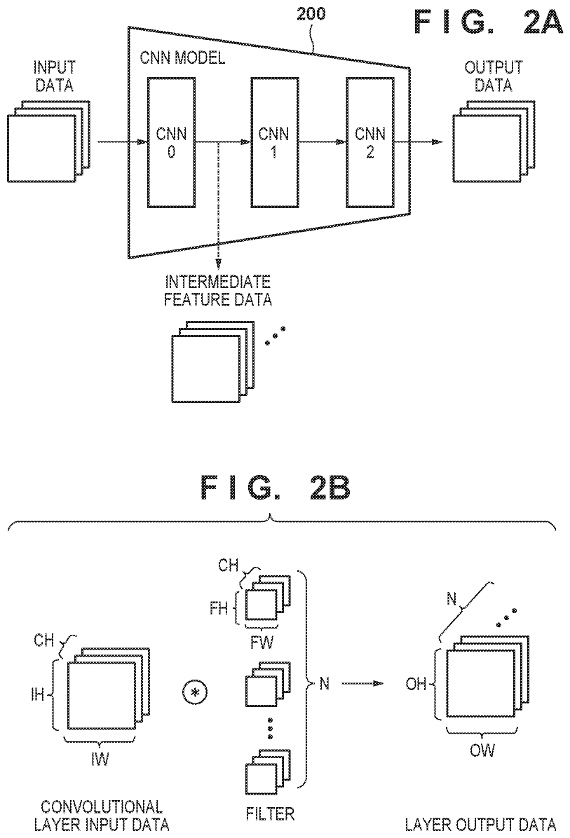

Next, an overview of a CNN operation will be described with reference to FIGS. 2A and 2B. As illustrated in FIG. 2A, generally, CNN processing is repeated a plurality of times in a CNN operation. However, the CNN processing is not limited to a plurality of times. A CNN model 200 includes a CNN 0, a CNN 1, and a CNN 2, each representing CNN processing. The CNN 0, the CNN 1 and the CNN 2 each represent a convolutional layer, and output data of the previous layer will be input data of the next layer. Layers other than an input layer and an output layer are referred to as intermediate layers, and input/output data of the intermediate layers are referred to as intermediate feature data. A configuration of a CNN model is not limited to the form illustrated in FIG. 2A.

FIG. 2B illustrates an input/output relationship in a convolutional layer. IH indicates a vertical data length of input data, and IW indicates a horizontal data length of input data, and CH indicates the number of channels of input data. In addition, FH indicates a vertical data length of a filter, FW indicates a horizontal data length of a filter, N indicates the number of filters included in a convolutional layer, OH indicates a vertical data length of output data, and OW indicates a horizontal data length of output data. In this case, the number of channels of intermediate feature data after a convolution operation corresponds to the number of filters in a respective layer. This convolution operation is performed in each layer of a CNN model.

When a bit depth of input data is set to be Y bits, the amount of input data of each layer is as indicated by Equation (1), and the amount of output data is as indicated by Equation (2).

[EQUATION 1]

IH×IW×CH×Y/8[bytes] (1)

[EQUATION 2]

OH×OW×N×Y/8[bytes] (2)

In addition, the number of filters of each layer from an input layer to a layer immediately preceding the output is generally larger than the number of channels of input data/output data of a CNN model. For example, when an image consisting of three channels is set to be input data of a CNN model and the number of filters of an input layer is set to be 16, intermediate feature data outputted by the input layer is data consisting of 16 channels. Of course, the number of channels of intermediate feature data may consist of another number of channels.

The CPU 101 loads the CNN model parameters stored in the external memory 102 into the sum-of-products operation processing unit 105 according to signal processing contents. As the sum-of-products operation processing unit 105 performs sum-of-products operation processing, post-sum-of-products operation processing data is stored in the shared memory 106. The CPU 101 performs arithmetic operations other than a sum-of-products operation, such as an activation function operation, among CNN operations on data loaded into the shared memory 106. A rectified linear unit (ReLU), for example, is used for the activation function. In the present embodiment, description will be given using as an example a case where the CPU 101 performs the activation function operation; however, another processor may perform the activation function operation. In the above description, a description has been given using as an example a case where convolution is executed in single layer units; however, convolution may be executed in multiple layer units.

In the following description of the present embodiment, a case where a memory configuration including, for example, the low-speed, large-capacity external memory 102 and the high-speed, small-capacity shared memory 106 will be described. However, the memory configuration is not limited to this, and another configuration may be used so long as the signal processing apparatus 100 includes a sufficient memory necessary for CNN operation processing. In addition, each component may be connected directly without going through the internal bus 103.

<Overview of Transfer Data>

The signal processing apparatus 100 according to the present embodiment generates input/output transfer data by further performing a neural network-based operation on intermediate feature data. Therefore, an overview of transfer data according to the present embodiment will be described. In the following description, data to be loaded from the external memory 102 for the sum-of-products operation processing unit 105 to perform processing is referred to as input transfer data. In addition, data to be stored in the external memory 102 after processing in the sum-of-products operation processing unit 105 is referred to as output transfer data.

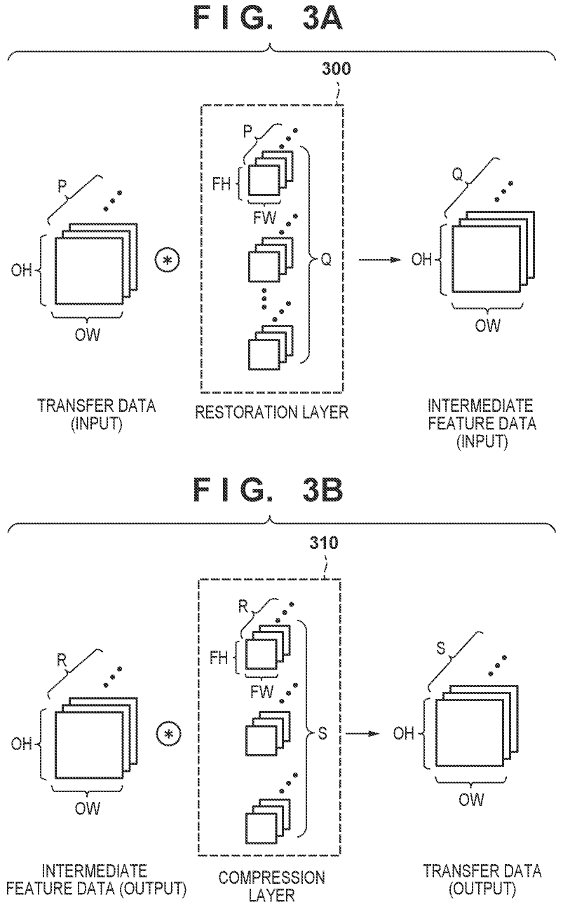

FIGS. 3A and 3B illustrate a relationship between intermediate feature data and transfer data at input and output, respectively. In the example of FIGS. 3A and 3B, a filter configuration FH and FW used in a restoration layer 300 and a compression layer 310 are made to be in common with the filter configuration FH and FW illustrated FIG. 2B as one example. That is, intermediate feature data to be inputted to a convolution operation of a layer of a CNN model is outputted for transfer data stored in the external memory 102 according to an arithmetic operation of the restoration layer 300, which is configured by a neural network and restores pre-compression data. In addition, transfer data is outputted for intermediate feature data outputted from a convolution operation of a layer of a CNN model according to an arithmetic operation of the compression layer 310, which is configured by a neural network and compresses data.

The configuration of the restoration layer 300 and the compression layer 310 are not limited to this. The filter configuration need not be set such that the configuration is the same between the restoration layer 300 and the compression layer 310. In addition, although the restoration layer 300 and the compression layer 310 are each illustrated as a single convolutional layer in the example illustrated in FIGS. 3A and 3B, they may each be configured by a plurality of convolutional layers or by a fully-connected layer. The restoration layer 300 and the compression layer 310 are not limited to the above-described example so long as they are configured by a model whose arithmetic operation contents are specified by training (in other words, they are not configured by predetermined rule-based operation), as with a neural network.

FIG. 3A illustrates a relationship between input transfer data transferred from the external memory 102 to the sum-of-products operation processing unit 105, the restoration layer 300 for performing data restoration processing, and intermediate feature data to be processed by a convolutional layer of a CNN model. For example, when the number of channels of input transfer data is P, the number of channels of a filter of the restoration layer 300 will be P. In addition, for example, when the number of filters of the restoration layer 300 is defined as Q, the number of channels of intermediate feature data will be Q. It is assumed that a relationship between P and Q in FIG. 3A satisfies Equation (3).

[EQUATION 3]

P<Q (3)

FIG. 3B illustrates a relationship between intermediate feature data, which is output of a convolutional layer of a CNN model, the compression layer 310 for performing data compression processing, and output transfer data to be transferred from the sum-of-products operation processing unit 105 to the external memory 102. For example, when the number of channels of intermediate feature data is R, the number of channels of a filter of the compression layer 310 will be R. In addition, for example, when the number of filters of the compression layer 310 is defined as S, the number of channels of output transfer data will be S. It is assumed that a relationship between R and S in FIG. 3B satisfies Equation (4).

[EQUATION 4]

R>S (4)

For example, the restoration layer 300 and the compression layer 310 according to the present embodiment are configured to satisfy Equations (3) and (4), respectively. That is, the amount of information of transfer data is smaller than the amount of information of intermediate feature data. That is, the amount of information of intermediate feature data is greater than the amount of information of input transfer data due to the restoration layer 300. Meanwhile, the amount of information of output transfer data is smaller than the amount of information of intermediate feature data due to the compression layer 310. For example, when P is half of Q, the amount of information of input transfer data is half of the amount of information of intermediate feature data. The relationship between P and Q and the relationship between R and S are not limited to these.

<Method of Training Compression Layer and Restoration Layer>

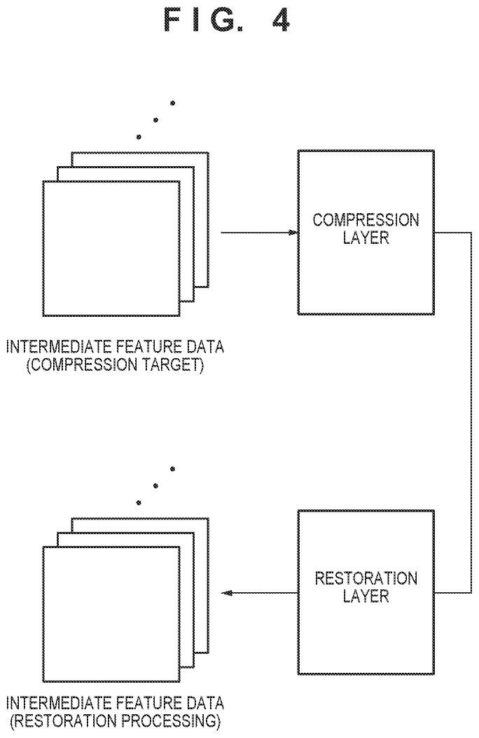

Next, a method of training the compression layer and the restoration layer will be described with reference to FIG. 4. In the example illustrated in FIG. 4, an example in which only the compression layer and the restoration layer are combined and these are trained as a training model is described. In this example, input data (i.e., compression target data) of a neural network (simply referred to as a compression restoration network) in which only the compression layer and the restoration layer are combined is intermediate feature data of a CNN model to which the compression layer and the restoration layer are to be applied. In addition, in this example, training data of the compression restoration network is intermediate feature data of a CNN model, which is also input data. The compression restoration network is trained such that restored intermediate feature data, which is output of the compression restoration network, is closer to being the same as the training data. By the training environment of the compression restoration network being defined in this way, the training model (i.e., the compression restoration network) can be trained so as to compress the number of channels of intermediate feature data in the compression layer and restore the number of channels of intermediate feature data in the restoration layer. Training of the compression restoration network described here may be performed individually or in common for each layer of a plurality of layers included in the CNN model 200 to which the compression restoration network will be applied or for each predetermined processing unit consisting of a plurality of layers.

In addition, when the CNN model 200 does not have common input/output data configurations due to, for example, a difference in the number of filters in each layer or a predetermined processing unit, the compression layer and the restoration layer of the compression restoration network illustrated in FIG. 4 may be prepared for each input/output data configuration. That is, a compression layer associated with a convolution operation of one layer and a compression layer associated with a convolution operation of another layer may be configured to perform different arithmetic operations. Of course, different compression layers may be configured to perform the same arithmetic operation. In the description of FIG. 4, a case where the training of the compression restoration network is supervised training has been described as one example. However, the training of the compression restoration network is not limited to supervised training and may be another training in which intermediate feature data is used.

<Transfer Data Conversion Processing>

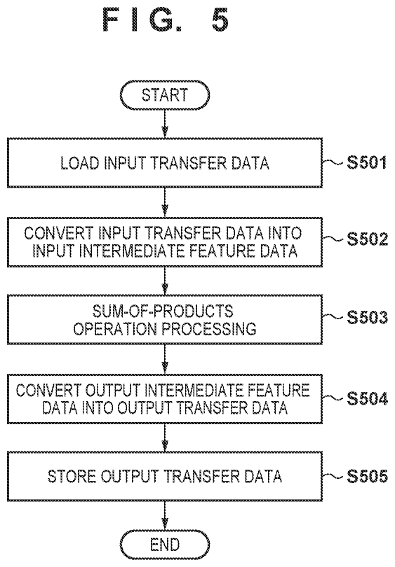

Next, processing for compressing intermediate feature data of a CNN model into transfer data or restoring intermediate feature data from transfer data and transmitting and receiving data between the sum-of-products operation processing unit 105 and the external memory 102 will be described with reference to FIG. 5. The operation of the conversion processing is realized by the CPU 101 and the sum-of-products operation processing unit 105 each executing a program stored in the storage 108. In addition, the compression layer and the restoration layer are realized by a trained configuration (i.e., a configuration in which trained inter-neuron weight parameters are used) specified by the above-described training of the compression layer and the restoration layer. In other words, processing according to the compression layer and the restoration layer is inference stage processing according to a trained neural network configuration. In the following processing, description will be given using as an example, a case where the CPU 101 and the sum-of-products operation processing unit 105 execute steps to be described later; however, the CPU 101 may execute the processing instead of the sum-of-products operation processing unit 105, or vice versa.

In step S501, the CPU 101 reads out input transfer data stored in the external memory 102 and loads it into the shared memory 106. In addition, parameters, such as filters of the restoration layer, are also stored in the shared memory 106 or the sum-of-products operation processing unit 105.

In step S502, the sum-of-products operation processing unit 105 converts the input transfer data into intermediate feature data. At this time, the CPU 101 loads in advance the input transfer data into the sum-of-products operation processing unit 105. When the restoration layer is not loaded into the sum-of-products operation processing unit 105, the CPU 101 also loads the restoration layer into the sum-of-products operation processing unit 105. The sum-of-products operation processing unit 105 restores intermediate feature data (for the sake of convenience, referred to as input intermediate feature data) by applying a restoration layer-based operation on the input transfer data.

In step S503, when the CPU 101 inputs the input intermediate feature data and the parameters of the CNN model 200 to the sum-of-products operation processing unit 105, the sum-of-products operation processing unit 105 performs a sum-of-products operation on the inputted input intermediate feature data. The sum-of-products operation processing unit 105 stores a result of the sum-of-products operation, in which parameters, such as filters of the CNN model 200 are used, on the input intermediate feature data in the shared memory 106. Alternatively, when it is possible to hold the input intermediate feature data in the sum-of-products operation processing unit 105, the sum-of-products operation processing unit 105 holds the input intermediate feature data.

In step S504, the sum-of-products operation processing unit 105 converts output intermediate feature data, which is a result of a sum-of-products operation of the sum-of-products operation processing unit 105 stored in the shared memory 106, into output transfer data. In this case, the compression layer is loaded into the shared memory 106 or the sum-of-products operation processing unit 105. When the compression layer or the output intermediate feature data is not loaded into the sum-of-products operation processing unit 105, the CPU 101 loads the compression layer or the output intermediate feature data from the shared memory 106 to the sum-of-products operation processing unit 105. The sum-of-products operation processing unit 105 can obtain output transfer data from the output intermediate feature data and a compression layer-based operation. The sum-of-products operation processing unit 105 stores the obtained output transfer data in the shared memory 106.

In step S505, the CPU 101 stores the output transfer data stored in the external memory 102 to the shared memory 106. When the output transfer data is stored in the external memory 102, the CPU 101 terminates the series of processes.

The above processing described with reference to FIG. 5 is repeated in the processing from an input layer to an output layer of a CNN model. In the above description, it has been described that the processing starts in step S501; however, there may be cases where a part of the processing described in FIG. 5 is performed. In addition, it is assumed that the compression layer and the restoration layer described with reference to FIG. 5 are selected based on that they correspond to each layer of the CNN model or to processing units consisting of a plurality of layers.

The processing described with reference to FIG. 5 is only one example. For example, if a plurality of sum-of-products operation processing units 105 are provided, the processing in step S502 and the processing in step S503 may be executed in separate sum-of-products operation processing units. In this case, the input intermediate feature data is transferred from the sum-of-products operation processing unit in which step S502 is executed to the sum-of-products operation processing unit in which step S503 is executed. Similarly, the processing in step S503, and the processing in step S504 may be executed in different sum-of-products operation processing units. In this case, the output intermediate feature data is transferred from the sum-of-products operation processing unit in which step S503 is executed to the sum-of-products operation processing unit in which step S504 is executed. When a plurality of sum-of-products operation processing units are thus provided, pipeline processing may be performed without waiting for the CPU 101 to load the compression layer or the restoration layer and the CNN model parameters to the sum-of-products operation processing units.

As described above, in the present embodiment, in the CNN operation processing, intermediate feature data to be processed by the sum-of-products operation processing unit 105 is compressed into transfer data in a trained compression layer and transfer data is restored to the intermediate feature data in a trained restoration layer. The compression layer and the restoration layer are trained such that the restoration layer restores pre-compression intermediate feature data. In this manner, a mechanism capable of preventing, by training, accuracy deterioration caused by compression and restoration of a result of computation of a neural network is provided. In addition, it is possible to reduce the amount of data to be stored in the external memory 102 while reducing data loss even when intermediate feature data is compressed and restored. That is, it is possible to realize a reduction in data bandwidth while preventing deterioration of computational accuracy when transferring data in the middle of a neural network-based operation.

### Second Embodiment

In the first embodiment, the training of the compression layer and the restoration layer is performed with only the compression layer and the restoration layer using the compression restoration network, which is separate from the CNN model 200 and in which only the compression layer and the restoration layer are combined. In a second embodiment, the computational capabilities of the CNN model in which the compression layer and the restoration layer are included is optimized by including the compression layer and the restoration layer in the CNN model and training the CNN model. The signal processing apparatus according to the second embodiment can have a configuration similar to that of the signal processing apparatus 100 described in the first embodiment. In addition, the CNN operation illustrated in FIGS. 2A and 2B, the relationship between intermediate feature data and transfer data illustrated in FIGS. 3A and 3B, and the processing illustrated in FIG. 5 can be similar to those of the first embodiment. Therefore, the same configuration or processing is given the same reference number, overlapping description will be omitted, and points of difference will mainly be described.

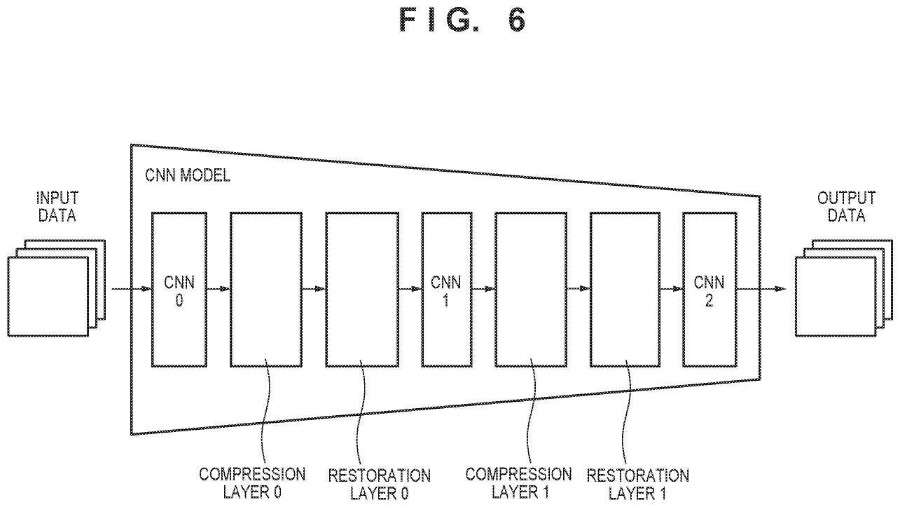

A configuration in which a compression layer and a restoration layer are included in the CNN model and trained will be described with reference to FIG. 6. As illustrated in FIG. 6, in the present embodiment, a compression layer is included downstream of the output of each layer of the CNN model and a restoration layer is included upstream of the input of each layer of the CNN model. Specifically, configuration is taken such that layers continue in order of the CNN 0 indicating an input layer of the CNN model, a compression layer 0 corresponding to a data configuration of the CNN 0, a restoration layer 0, and the CNN 1 indicating a second layer of the CNN model. Training is executed such that, when the CNN 0 is set as the input layer and the CNN 2 is set as the output layer, the accuracy of output data increases in a neural network having the configuration illustrated in FIG. 6. In this manner, each layer of the CNN and each of the compression layer and the restoration layer can be trained simultaneously using the training data for the CNN model.

In the example illustrated in FIG. 6, the input/output data have a three-channel configuration and the CNN model has a three-layer configuration; however, the configurations of the input/output data and the CNN model are not limited to these. In addition, although the CNN model has a configuration in which a compression layer and a restoration layer are interposed between the input/output of each layer, another configuration may be taken. In addition, although the respective training methods of the first embodiment and the second embodiment have been described, the prevent invention is not limited to selecting and executing one method, and either method may be selected for each layer or for each processing unit.

As described above, the computational capabilities of the CNN model in which compression layers and restoration layer are included can be optimized by training a neural network in which compression layers and restoration layers are included in the configuration of the CNN model. Therefore, by applying the training method according to the present embodiment, it is possible to reduce the effect on the accuracy of the CNN model for when the compression layers and the restoration layers are applied. Accordingly, it is possible to reduce the amount of data to be loaded from the external memory 102 or stored in the external memory 102 while reducing the effect on the accuracy of CNN operation processing.

### Third Embodiment

In the first embodiment, a case where a necessary bandwidth of the internal bus 103 of the signal processing apparatus 100 is reduced has been described as an example. In a third embodiment, a case where a bandwidth is reduced in a signal processing system in which a plurality of signal processing apparatuses are used will be described. In the third embodiment, transfer data, which has been outputted according to an arithmetic operation of a compression layer of a signal processing apparatus 700, is transmitted to an apparatus external to the signal processing apparatus 700 in order to store the transfer data in a memory or the like of the external apparatus. At this time, it is possible to reduce the amount of data to be communicated between signal processing apparatuses by transmitting and receiving the transfer data according to the present embodiment.

In the third embodiment, it is possible to similarly use the CNN operation indicated in FIGS. 2A and 2B and the intermediate feature data indicated in FIGS. 3A and 3B in the first embodiment. In addition, in the third embodiment, it is possible to similarly use the training method indicated in FIG. 4 or 6 in the first embodiment or the second embodiment. Therefore, the same configuration or processing is given the same reference number, overlapping description will be omitted, and points of difference will mainly be described.

<Configuration of Signal Processing System According to Plurality of Signal Processing Apparatuses>

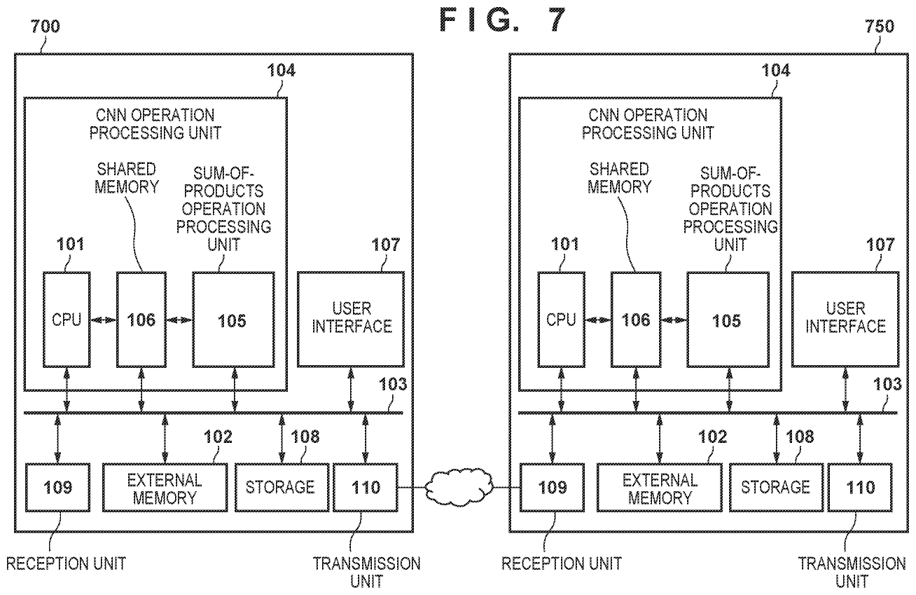

Data transmission and reception in which a plurality of signal processing apparatuses are used will be described with reference to FIG. 7. Although the signal processing apparatus 700 in FIG. 7 shares the basic configuration with the signal processing apparatus 100 in FIG. 1, the signal processing apparatus 700 in FIG. 7 further includes a reception unit 109 and a transmission unit 110. The reception unit 109 receives data inputted from a unit external to the signal processing apparatus 700 and stores the data to the external memory 102 or the shared memory 106 via the internal bus 103. Meanwhile, the transmission unit 110 transmits data stored in the external memory 102 or the shared memory 106 and data outputted from the sum-of-products operation processing unit 105 to a unit external to the signal processing apparatus 700. In addition, description will be given assuming that a configuration of a signal processing apparatus 750 is similar to that of the signal processing apparatus 700.

In the signal processing system illustrated in FIG. 7, data transmitted from the transmission unit 110 of the signal processing apparatus 700 is received by a reception unit 109 of the signal processing apparatus 750. The communication between the transmission unit 110 of the signal processing apparatus 700 and the reception unit 109 of the signal processing apparatus 750 may be wired communication or wireless communication. The configuration of the signal processing system in which the signal processing apparatus 700 and the signal processing apparatus 750 are included is not limited to this example, and the signal processing system may be configured by more signal processing apparatuses. In addition, the configurations of the signal processing apparatus 700 and the signal processing apparatus 750 are only one example, and the number and configuration of each unit are not limited to this example.

<Transfer Data Transmission/Reception Processing>

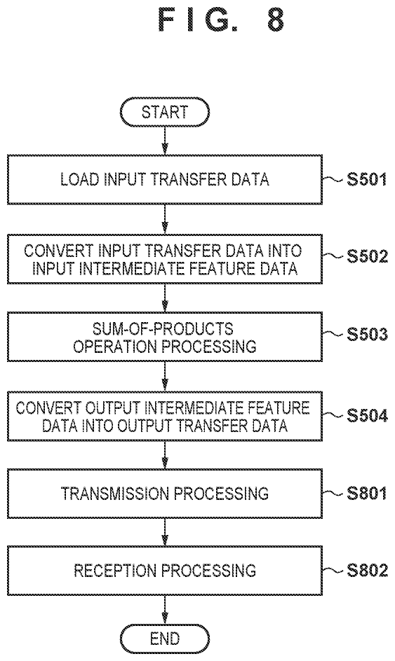

Transfer data transmission/reception processing in the signal processing system illustrated in FIG. 7 will be described with reference to FIG. 8. The operation of this processing is realized by the CPU 101 and the sum-of-products operation processing unit 105 each executing a program stored in the storage 108 in the signal processing apparatus 700. In addition, processing to be performed in the signal processing apparatus 750 is realized by the CPU 101 and the sum-of-products operation processing unit 105 of the signal processing apparatus 750 each executing a program stored in the storage 108 of the apparatus. In addition, similarly to the first embodiment, the processing according to the compression layer and the restoration layer to be used in each apparatus is inference stage processing according to a trained neural network configuration.

Similarly to the first embodiment, the CPU 101 or the sum-of-products operation processing unit 105 of the signal processing apparatus 700 executes the processing from step S501 to step S504.

In step S801, the CPU 101 of the signal processing apparatus 700 loads output transfer data outputted from the sum-of-products operation processing unit 105 into the transmission unit 110. The output transfer data may be stored in the external memory 102 or the shared memory 106, and in such a case, the output transfer data is loaded from the external memory 102 or the shared memory 106 into the transmission unit 110. After the output transfer data has been loaded into the transmission unit 110, the transmission unit 110 of the signal processing apparatus 700 transmits the output transfer data to the signal processing apparatus 750.

In step S802, the reception unit 109 of the signal processing apparatus 750 receives the output transfer data transmitted from the transmission unit 110 of the signal processing apparatus 700. The CPU 101 of the signal processing apparatus 750 stores the received output transfer data in the external memory 102 or the shared memory 106. Then, the processing is terminated.

In the above description, a case where, in step S501, the signal processing apparatus 700 loads the input transfer data stored in the external memory 102 to the shared memory has been described as an example. However, instead of step S501, the signal processing apparatus 700 may receive the input transfer data from the signal processing apparatus 750 or another signal processing apparatus and load the received input transfer data to the shared memory.

As described above, in the present embodiment, transfer data obtained by converting intermediate feature data is transmitted and received between signal processing apparatuses in a signal processing system configured by a plurality of signal processing apparatuses. In this manner, it is possible to reduce a communication bandwidth between signal processing apparatuses.

### Fourth Embodiment

A fourth embodiment is different from the first embodiment in that intermediate feature data is converted to transfer data using a compression method based on a memory bandwidth for the external memory 102. Although a signal processing apparatus 900 according to the fourth embodiment is different from the signal processing apparatus 100 in the configuration and operation for varying the compression method, other configurations and operations are similar to the signal processing apparatus 100. That is, in the fourth embodiment, the CNN operation illustrated in FIGS. 2A and 2B and the intermediate feature data illustrated in FIGS. 3A and 3B are similar, and the training method illustrated in FIG. 4 or FIG. 6 is also similar to those of the first embodiment. Therefore, configurations or processing that are the same as those of the above-described embodiments are given the same reference number, description thereof will be omitted, and points of difference will mainly be described.

<Configuration of Signal Processing Apparatus 900>

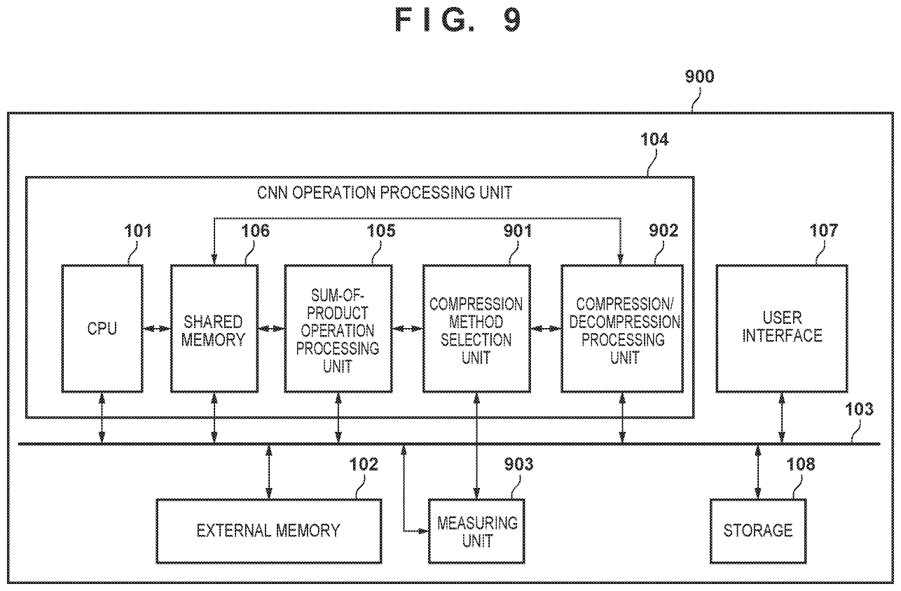

An example of a configuration of the signal processing apparatus 900 according to the fourth embodiment will be described with reference to FIG. 9. The signal processing apparatus 900 further includes a measuring unit 903, a compression method selection unit 901, and a compression/decompression unit 902 in addition to the configuration of the signal processing apparatus 100 illustrated in FIG. 1.

The measuring unit 903 measures a memory bandwidth of the external memory 102 and calculates an available memory bandwidth between the external memory 102 and the shared memory 106 for transfer data. The compression method selection unit 901 selects a method of compressing and restoring intermediate feature data based on the memory bandwidth calculated by the measuring unit 903. The compression/decompression unit 902 performs compression from intermediate feature data to transfer data and decompression from transfer data to intermediate feature data. The compression/decompression unit 902 is not limited to a portable network graphics (PNG) method so long as the compression/decompression method is lossless, such as in the PNG method. When selecting the compression/decompression method, it is desirable to select a method in which the sum of the time it takes for compression and decompression and the time it takes to transfer the transfer data is short. In the following description, description will be given using as an example a case where a compression ratio for compression of intermediate feature data by the compression layer is higher than a compression ratio for compression of intermediate feature data according to a lossless compression method.

<Selection of Data Conversion Method>

The compression method selection unit 901 selects either the sum-of-products operation processing unit 105 or the compression/decompression unit 902 as a method of converting intermediate feature data into transfer data and notifies the CPU 101 of the selected method.

When the volume of intermediate feature data is T, the compression ratio of the compression/decompression unit 902 is U, and the available memory bandwidth calculated by the measuring unit 903 is V, if the following Equation (5) is satisfied, the compression/decompression unit 902 is selected and intermediate feature data and transfer data are converted.

[EQUATION 5]

T×U<V (5)

This is because, in contrast to the lossless compression method of the compression/decompression unit 902, the compression and restoration in which the sum-of-products operation processing unit 105 is used accords with training, and when unlearned data is inputted, the compression may not always be lossless. When the compression is not lossless, it may lead to accuracy deterioration of the operation processing according to the CNN model.

Therefore, in the present embodiment, when Equation (5) is satisfied, the compression method selection unit 901 selects the compression/decompression unit 902, which is a lossless method in which the accuracy does not deteriorate, so long as it does not lead to reduction in speed due to the processing time required for compression and restoration. When Equation (5) is not satisfied, a method of higher compression ratio (e.g., compression by the compression layer of the sum-of-products operation processing unit 105) is selected. This makes it possible to alleviate the reduction in speed of the operation processing according to the CNN model due to data transfer time.

<Transfer Data Conversion Processing>

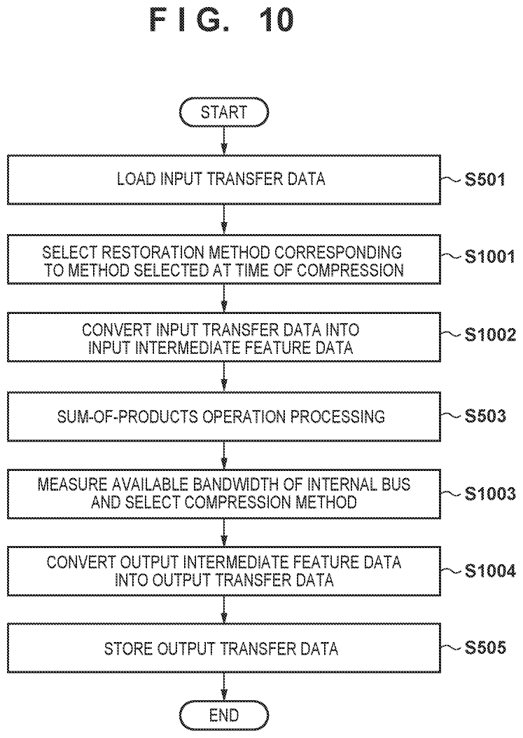

Next, processing for converting intermediate feature data of the CNN model into transfer data and communicating the intermediate feature data between the sum-of-products operation processing unit 105 or the compression/decompression unit 902 and the external memory 102 will be described with reference to FIG. 10. The operation of the conversion processing is realized by the CPU 101 and the sum-of-products operation processing unit 105 each executing a program stored in the storage 108. In addition, as described above, the compression layer and the restoration layer realized by the sum-of-products operation processing unit 105 are realized by a trained configuration (i.e., a configuration in which trained inter-neuron weight parameters are used) specified by the above-described training of the compression layer and the restoration layer.

Similarly to the first embodiment, the CPU 101 executes step S501 and loads input transfer data to the shared memory 106.

In step S1001, the CPU 101 selects a restoration method corresponding to the method selected at the time of compression by the compression method selection unit 901. In step S1002, the CPU 101 obtains input intermediate feature data from the input transfer data using the method selected in step S1001. Similarly to step S502 of the first embodiment, when the sum-of-products operation processing unit 105 is selected as the restoration method, for example, the input intermediate feature data is obtained by the sum-of-products operation processing unit 105. Meanwhile, when the compression/decompression unit 902 is selected, input intermediate feature data is obtained from the input transfer data by decompression. Initial input transfer data is stored in an uncompressed manner; therefore, the input transfer data is obtained as input intermediate feature data without computation processing being performed. Then, similarly to the first embodiment, in step S503, the sum-of-products operation processing unit 105 performs a sum-of-products operation.

In step S1003, the CPU 101 measures a memory bandwidth via the measuring unit 903 and selects a compression method via the compression method selection unit 901 according to the above-described method. In step S1004, the CPU 101 converts output intermediate feature data into output transfer data according to the method selected in step S1003. Similarly to the first embodiment, when the sum-of-products operation processing unit 105 is selected, the sum-of-products operation processing unit 105 converts output intermediate feature data into output transfer data. When the compression/decompression unit 902 is selected, output intermediate feature data is converted into output transfer data according to the above-described lossless compression method. Similarly to the first embodiment, in step S505, the CPU 101 stores the output transfer data in the external memory. When the output transfer data is stored in the external memory 102, the CPU 101 terminates the series of processes.

The above processing described with reference to FIG. 10 is repeated in the processing from an input layer to an output layer of a CNN model. It has been described that the processing starts in step S501 with reference to FIG. 10; however, there may be cases where a part of the processing described in FIG. 10 is performed. In addition, similarly to the first embodiment, it is assumed that the compression layer and the restoration layer are selected based on that they correspond to each layer of the CNN model or to processing units consisting of a plurality of layers.

In addition, in the above description, for the sake of convenience, a case where the compression/decompression unit 902 is configured by one block has been described as an example; however, the compression/decompression unit 902 may be configured by a plurality of blocks corresponding to different compression ratios. The compression/decompression unit 902 may select one from a plurality of compression ratios within a range that satisfies Equation (5) and convert between intermediate feature data and transfer data. Alternatively, as another configuration method, the compression/decompression unit 902 may be configured such that the compression ratio can be changed by adjusting the quantization value and, thereby change the compression ratio within a range that satisfies Equation (5) and convert between intermediate feature data and transfer data.

As described above, in the present embodiment, in the CNN operation processing, a compression method is selected from compression by the sum-of-products operation processing unit 105 and compression of the compression/decompression unit 902, and conversion into transfer data is performed. In this manner, it is possible to reduce the amount of data to be loaded from the external memory 102 or stored in the external memory 102 while preventing accuracy deterioration of data, which has been restored due to having been compressed. By reducing the amount of data to be communicated, it is possible to reduce the bus bandwidth necessary for CNN operation processing.

### Fifth Embodiment

A fifth embodiment includes a function for selecting a compression method of the signal processing apparatus when a memory bandwidth for when loading or storing transfer data in the external memory 102 is determined. Although a signal processing apparatus 1100 according to the fifth embodiment is different from the signal processing apparatus 900 in the configuration and operation for selecting the compression method, other configurations and operations are similar to the signal processing apparatus 900. That is, the fifth embodiment is similar in terms of the components illustrated in the fourth embodiment, the CNN operation illustrated in FIGS. 2A and 2B, and the intermediate feature data illustrated in FIGS. 3A and 3B and is also similar in terms of the training method illustrated in FIG. 4 or 6 in the first embodiment. Therefore, configurations or processing that are the same as in the above-described embodiments are given the same reference number, description thereof will be omitted, and points of difference will mainly be described.

<Configuration of Signal Processing Apparatus 1100>

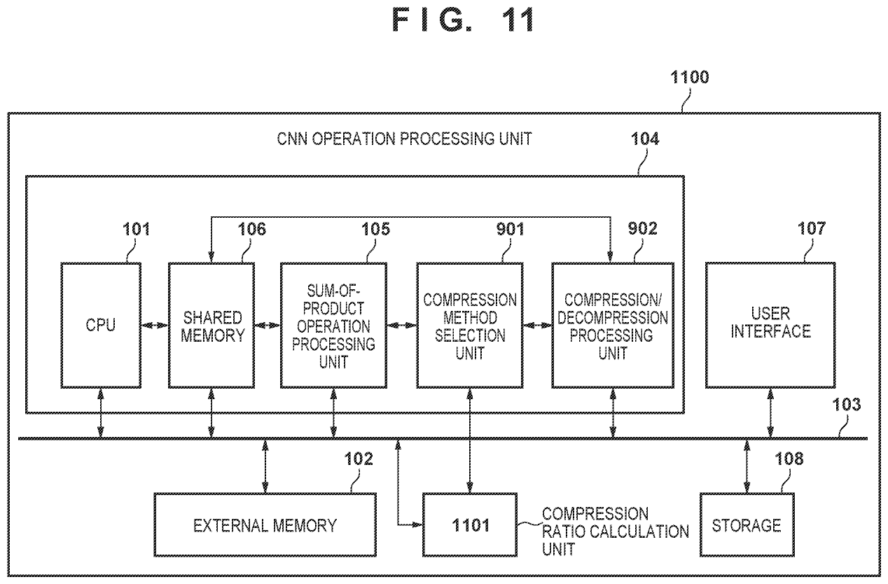

An example of a configuration of the signal processing apparatus 1100 according to the fifth embodiment will be described with reference to FIG. 11. The signal processing apparatus 1100 includes a compression ratio calculation unit 1101 instead of the measuring unit 903 in the configuration of the signal processing apparatus 900 illustrated in FIG. 9. The compression ratio calculation unit 1101 calculates, based on the volume of output intermediate feature data in a layer of the CNN model and a predetermined memory bandwidth, a compression ratio necessary for when converting output transfer data. The compression ratio calculation unit 1101 notifies the compression method selection unit 901 of the calculated compression ratio.

<Compression Ratio Calculation Method>

When X is the volume of output data of a single layer in the CNN convolution layers and Y is the predetermined available memory bandwidth, a method of calculating a compression ratio performed by the compression ratio calculation unit 1101 follows Equation (6).

[EQUATION 6]

X÷Y (6)

X, which is the volume of output data of a single layer in Equation (6), is the amount of output data indicated in Equation (2) described in the first embodiment. In addition, the available memory bandwidth Y indicated in Equation (6) is a memory bandwidth that can be used in the transfer between the shared memory 106 and external memory 102 in the sum-of-products operation processing according to the CNN model, according to the operation state of the signal processing apparatus 1100. The operation state of the signal processing apparatus 1100 is, for example, when the CPU 101 performs the CNN operation processing and when the CPU 101 performs, as pipeline processing, image correction processing. In such cases, the CPU 101 and the shared memory 106 need to simultaneously transfer data to the external memory 102. Therefore, if the memory bandwidth used by the shared memory 106 is not limited, the CPU 101 and the external memory 102 will be prevented from performing the transfer. Therefore, by converting data at the compression ratio obtained by Equation (6), it is possible to reduce the memory bandwidth of the data transfer for the sum-of-products operation processing according the CNN model.

<Transfer Data Conversion Processing>

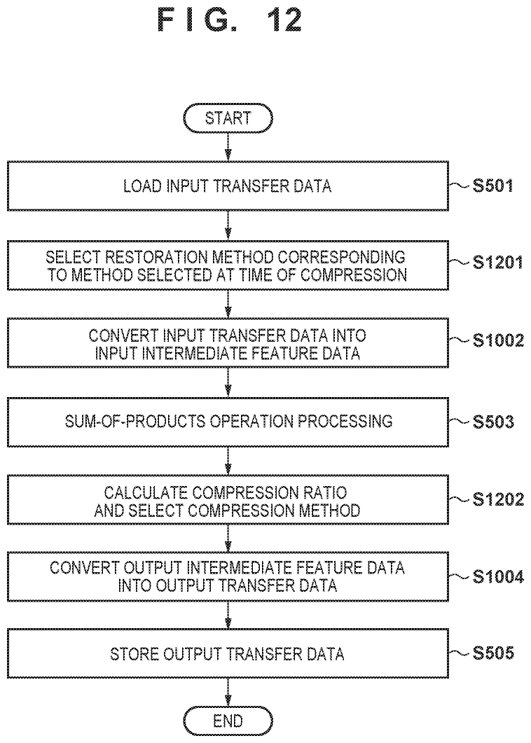

The processing for converting intermediate feature data of the CNN model into transfer data and communicating the intermediate feature data between the sum-of-products operation processing unit 105 or the compression/decompression unit 902 and the external memory 102 will be described with reference to FIG. 12. Similarly to the fourth embodiment, the operation of the conversion processing is realized by the CPU 101 and the sum-of-products operation processing unit 105 each executing a program stored in the storage 108.

Similarly to the first embodiment, the CPU 101 executes step S501 and loads input transfer data into the shared memory 106.

In step S1201, the CPU 101 selects a restoration method corresponding to the compression method in which the compression ration calculated by the compression method selection unit 901 with the above-described calculation method is used. Similarly to the fourth embodiment, in step S1002, the CPU 101 obtains input intermediate feature data. Then, similarly to the first embodiment, in step S503, the sum-of-products operation processing unit 105 performs a sum-of-products operation.

In step S1202, the CPU 101 selects a compression method that satisfies the compression ratio calculated by the compression method selection unit 901 using the above-described compression ratio calculation method. Similarly to the fourth embodiment, in step S1004, the CPU 101 converts output intermediate feature data to output transfer data according to the method selected in step S1202. Then, similarly to the first embodiment, in step S505, the CPU 101 stores the output transfer data in the external memory. When the output transfer data is stored in the external memory 102, the CPU 101 terminates the series of processes.

The above processing described with reference to FIG. 12 is repeated in the processing from an input layer to an output layer of a CNN model. It has been described that the processing starts in step S501 with reference to FIG. 12; however, there may be cases where only a part of the processing described in FIG. 12 is performed. In addition, similarly to the first embodiment or the fourth embodiment, it is assumed that the compression layer and the restoration layer described with reference to FIG. 12 are selected based on that they correspond to each layer of the CNN model or to processing units consisting of a plurality of layers.

In the selection of the compression and restoration method, when it is determined that the compression ratio of the compression/decompression unit 902 satisfies Equation (6), it is desirable to select the compression/decompression unit 902. In this manner, similarly to in the selection of the data conversion method according to the fourth embodiment, it is possible to prevent the accuracy deterioration of the operation processing according to the CNN model by selecting a lossless compression/decompression method.

In addition, similarly to the fourth embodiment, the compression/decompression unit 902 may be configured by a plurality of blocks corresponding to different compression ratios. The compression/decompression unit 902 may select one from a plurality of compression ratios within a range that satisfies Equation (6) and convert between intermediate feature data and transfer data. Alternatively, as another configuration method, the compression/decompression unit 902 may be configured such that the compression ratio can be changed by adjusting the quantization value and, thereby, change the compression ratio within a range that satisfies Equation (6) and convert between intermediate feature data and transfer data.

As described above, in the present embodiment, an optimal compression method is selected after the compression ratio necessary for conversion of intermediate feature data and transfer data has been calculated. In this manner, it is possible to reduce the amount of data to be loaded from the external memory 102 or stored in the external memory 102 while preventing the accuracy deterioration of data caused by compression. Furthermore, by reducing the amount of data to be communicated, it is possible to reduce a bus bandwidth necessary for CNN operation processing also in a configuration in which a plurality of transfers to the external memory 102 occurs simultaneously.

### Sixth Embodiment

A sixth embodiment includes a function for converting intermediate feature data into transfer data using a compression/decompression method based on features of data to be inputted to the CNN operation processing unit 104. A signal processing apparatus 1300 according to the sixth embodiment is different from the signal processing apparatus 100 in that the signal processing apparatus 1300 includes an image determination processing unit to be described later and that the CNN operation processing unit 104 performs person recognition processing; however, other configurations and operations are similar to those of the signal processing apparatus 100. The CNN operation processing unit 104 according to the present embodiment is similar to the first embodiment in the configuration but is capable of performing person recognition processing for determining coincidence with a pre-registered person, taking face image data of a person as input. Therefore, configurations or processing that are the same as in the above-described embodiments are given the same reference numbers, description thereof will be omitted, and points of difference will mainly be described.

<Configuration of Signal Processing Apparatus 1300>

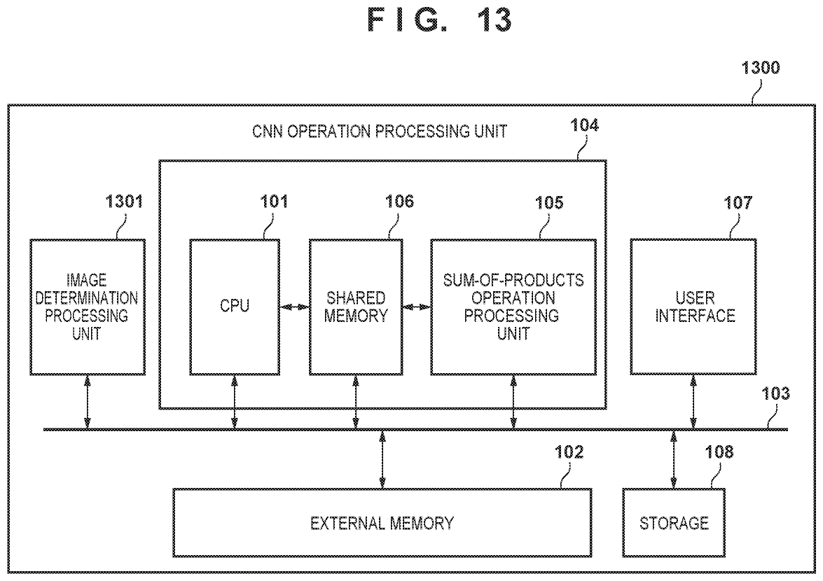

An example of a configuration of the signal processing apparatus 1300 according to the sixth embodiment will be described with reference to FIG. 13. The signal processing apparatus 1300 is similar to the configuration of the signal processing apparatus 100 illustrated in FIG. 1 regarding the CPU 101, the external memory 102, the internal bus 103, the CNN operation processing unit 104, the sum-of-products operation processing unit 105, the shared memory 106, the user interface 107, and the storage 108. An image determination processing unit 1301 determines features of image data to be inputted into the CNN operation processing unit 104.

<Person Recognition Processing>

The CNN operation processing unit 104 according to the present embodiment is capable of performing person recognition processing by computation of at least either the CPU 101 or the sum-of-products operation processing unit 105. The CNN operation processing unit 104 performs convolution processing on inputted face image data using filters for extracting features related to characteristic components, such as eyes, mouth, and the like, and generates intermediate feature data extracted for each feature, such as eyes and mouth. Next, the CNN operation processing unit 104 inputs the intermediate feature data extracted for each feature, performs convolution processing using a filter for extracting whether the feature coincides with the feature of a registered person, and generates intermediate feature data obtained by extracting a coincidence result for each feature, such as eyes and mouth. Lastly, the CNN operation processing unit 104 inputs the coincidence result for each feature, performs convolution processing using a filter for extracting whether the features coincide with those of a registered person, and outputs a recognition result.

<Image Determination Processing>

The image determination processing unit 1301 reads out face image data to be inputted into the CNN operation processing unit 104 from the external memory 102, determines a degree of importance for each piece of feature data generated by the CNN operation processing unit 104 based on a preset condition, and stores the determination result in the external memory 102. Here, the degree of importance is determined on the condition as to whether there is an element obstructing feature extraction. For example, when face image data to be inputted is that in which the person is wearing sunglasses, feature extraction of the eyes is obstructed, and therefore, feature data obtained by extracting the eye feature is determined to be of low importance. Similarly, when the person is wearing a mask, feature extraction of the mouth is obstructed, and therefore, feature data obtained by extracting the mouth feature is determined to be of low importance.

<Method of Applying Compression Layer and Restoration Layer>

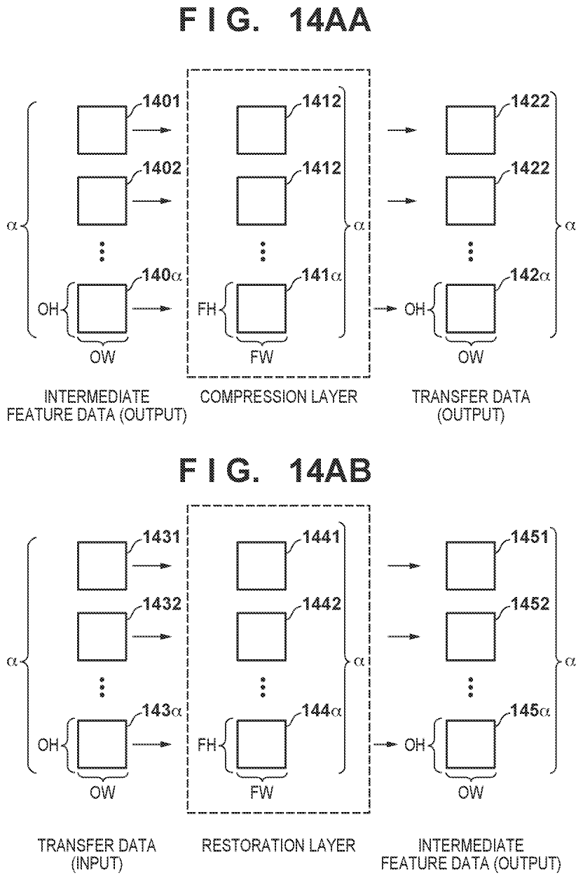

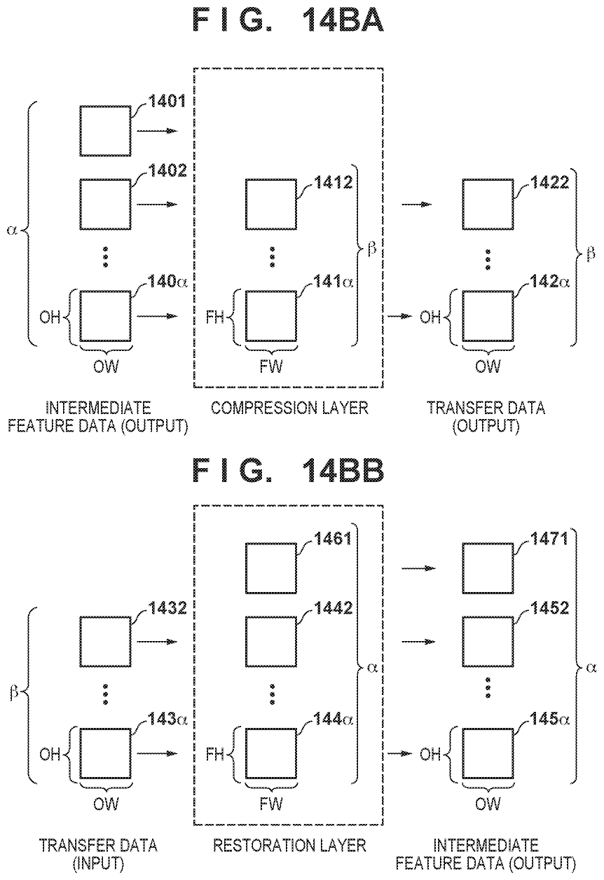

Next, a method of applying a compression layer and a restoration layer of the present embodiment will be described with reference to FIGS. 14AA and 14AB. FIG. 14AA illustrates a relationship between intermediate feature data, which is output of a convolutional layer of a CNN model, a compression layer for performing data compression processing, and output transfer data to be transferred to the external memory 102. Channels 1401, 1402, and 140a of the intermediate feature data are connected in a one-to-one manner to transfer data 1421, 1422, and 142a via filters 1411, 1412, and 141a of the compression layer and are configured such that intermediate feature data is outputted as is as transfer data.

FIG. 14AB illustrates a relationship between input transfer data transferred from the external memory 102 to the sum-of-products operation processing unit 105, the restoration layer 300 for performing data restoration processing, and intermediate feature data to be inputted to a convolutional layer of a CNN model. Channels 1431, 1432, and 143a of the transfer data are connected in a one-to-one manner to intermediate feature data 1451, 1452, and 145a via filters 1441, 1442, and 144a of the restoration layer and are configured such that intermediate feature data is outputted as is as transfer data.

FIG. 14BA illustrates a configuration of a compression layer for when it is determined that a degree of importance of given intermediate feature data is low in the image determination processing unit 1301. More specifically, contents of a change in the compression layer for when the degree of importance of the channel 1401 of the intermediate feature data is low are illustrated. When the degree of importance of the intermediate feature data is low, a valid result cannot be obtained even if that intermediate feature data is used in the subsequent CNN operation processing unit 104. Therefore, the filter 1411 corresponding to the intermediate feature data determined to be of low importance is deleted, and the transfer data 1421 is not outputted. When the number of items determined to be of low importance in the image determination processing unit 1301 is defined as γ and the number of filters in the compression layer and the number of channels of the transfer data are defined as β, β is obtained by Equation (7).

[EQUATION 7]

β=α−γ (7)

FIG. 14BB illustrates a configuration of a restoration layer for when it is determined that a degree of importance of given intermediate feature data is low in the image determination processing unit 1301. More specifically, contents of a change in the restoration layer for when the degree of importance of the intermediate feature data is determined to be low and the transfer data 1421 is not outputted is illustrated. A filter 1461 of the restoration layer is changed to have a filter characteristic that does not necessitate input of transfer data and outputs a value for when no feature is extracted as a fixed value. That is, whether to use transfer data is changed depending on the determined degree of importance. Similarly to the intermediate feature data 1451 restored in FIG. 14AB, intermediate feature data 1471 is used in the CNN operation processing unit.

When it is determined that the degree of importance is low by the image determination processing unit 1301, the target intermediate feature data is excluded from being a target of transfer data, and for intermediate feature data to be restored, a value for when no feature is extracted is used in the subsequent processing. In this manner, it is possible to reduce the amount of data to be loaded from the external memory 102 or stored in the external memory 102 while preventing the accuracy of final recognition result from being affected.

<Transfer Data Processing>

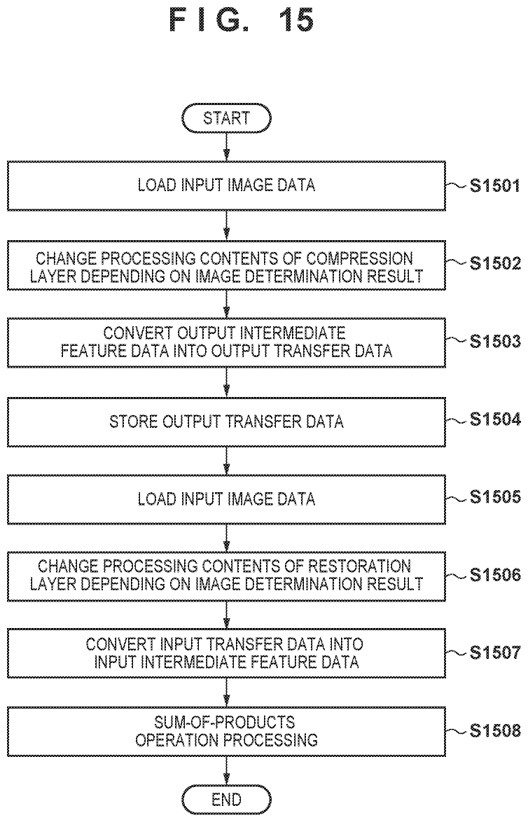

Next, processing for converting intermediate feature data of the CNN model into transfer data and communicating the intermediate feature data between the sum-of-products operation processing unit 105 and the external memory 102 will be described with reference to FIG. 15. The operation of the conversion processing is realized by the CPU 101 and the sum-of-products operation processing unit 105 each executing a program stored in the storage 108.

In step S1501, the CPU 101 loads input image data stored in the external memory 102 into the shared memory 106. In addition, parameters, such as filters of the compression layer, are also stored in the shared memory 106 or the sum-of-products operation processing unit 105.

In step S1502, the CPU 101 reads out a determination result of the image determination processing unit 1301 stored in the external memory 102. When there is an item determined to be of low importance in the determination result, the CPU 101 deletes the filter corresponding to the intermediate feature data determined to be of low importance in the compression layer as described above in FIG. 14BA. Thus, transfer data corresponding to the intermediate feature data determined to be of low importance is not outputted. The CPU 101 stores information of the deleted filter in the shared memory 106.

In step S1503, the sum-of-products operation processing unit 105 converts output intermediate feature data, which is a result of a sum-of-products operation of the sum-of-products operation processing unit 105 stored in the shared memory 106, into output transfer data. That is, the sum-of-products operation processing unit 105 obtains output transfer data from the output intermediate feature data by performing a compression layer-based operation. The sum-of-products operation processing unit 105 stores the output transfer data, which is a computation result, in the shared memory 106. In step S1504, the CPU 101 stores the output transfer data stored in the shared memory 106 to the external memory 102.

In step S1505, the CPU 101 loads input transfer data stored in the external memory 102 into the shared memory 106. In addition, parameters, such as filters of the restoration layer, are also stored in the shared memory 106 or the sum-of-products operation processing unit 105.

In step S1506, the CPU 101 reads out the deleted filter information data stored in the shared memory 106 and changes the filter characteristic to the form described above in FIG. 14BB. In step S1507, the CPU 101 loads input transfer data into the sum-of-products operation processing unit 105. The sum-of-products operation processing unit 105 obtains input intermediate feature data by performing a restoration layer-based operation on the input transfer data. In step S1508, the CPU 101 inputs the input intermediate feature data and the parameters of the CNN model to the sum-of-products operation processing unit 105, and the sum-of-products operation processing unit 105 performs a sum-of-products operation on the inputted input intermediate feature data. The CPU 101 then terminates the processing.

In the above description, for the sake of convenience, description has been given using as an example a case where the image determination processing unit 1301 and the CNN operation processing unit 104 are separately configured. However, configuration may be taken so as to provide only the CNN operation processing unit 104 and determine the degree of importance of intermediate feature data by analyzing the intermediate feature data in the CPU 101.

As described above, when conversion for intermediate feature data and transfer data is performed, conversion to transfer data is performed excluding the intermediate feature data of lower importance from the intermediate feature data computed in the CNN. In this manner, the amount of data to be stored in the external memory 102 can be reduced.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-122014, filed Jul. 29, 2022 which is hereby incorporated by reference herein in its entirety.

What is claimed is:

1. A signal processing apparatus comprising:
one or more processors; and
a memory storing instructions which, when the instructions are executed by the one or more processors, cause the signal processing apparatus to function as:
a processing unit configured to execute a convolution operation of predetermined layers constituting a neural network; and
a transfer unit connected with the processing unit and configured to transfer first form data to be stored in a storage unit,
wherein the processing unit further
executes, on output data outputted from a convolution operation of a first layer among the predetermined layers, an arithmetic operation of a compression layer that is configured by a neural network and compresses data, and outputs the first form data to be transmitted to the storage unit, and
executes, on the first form data stored in the storage unit, an arithmetic operation of a restoration layer that is configured by a neural network and restores pre-compression data, and outputs input data to be inputted to a convolution operation of a second layer among the predetermined layers.

2. The signal processing apparatus of claim 1, further comprising:
the storage unit connected with the transfer unit and configured to store the first form data outputted according to the arithmetic operation of the compression layer.

3. The signal processing apparatus of claim 1, wherein
the compression layer associated with the convolution operation of the first layer and a compression layer associated with the convolution operation of the second layer are configured to execute the same arithmetic operations.

4. The signal processing apparatus of claim 1, wherein
the compression layer associated with the convolution operation of the first layer and a compression layer associated with the convolution operation of the second layer are configured to execute different arithmetic operations.

5. The signal processing apparatus of claim 1, wherein
the processing unit is configured by a plurality of processing units, a first processing unit among the plurality of processing units executes the arithmetic operation of the compression layer and the restoration layer, and a second processing unit among the plurality of processing units executes the convolution operation of the predetermined layers.

6. The signal processing apparatus of claim 1, wherein
a neural network including the predetermined layers and a neural network including the compression layer and the restoration layer are configured as separate neural networks.

7. The signal processing apparatus of claim 6, wherein
the compression layer and the restoration layer are trained such that the input data obtained by inputting the first form data outputted from the compression layer to the restoration layer is closer to being the same as the data inputted to the compression layer.

8. The signal processing apparatus of claim 1, wherein
the compression layer, the restoration layer, and the predetermined layers are included in a single neural network, and
the first layer, the compression layer, the restoration layer, and the second layer are configured to be arranged in that order.

9. The signal processing apparatus of claim 8, wherein
the compression layer and the restoration layer are trained through training of the single neural network in which the first layer, the compression layer, the restoration layer, and the second layer are configured to be arranged in that order.

10. The signal processing apparatus of claim 1, further comprising:
a transmission unit configured to transmit the first form data outputted according to the arithmetic operation of the compression layer to an apparatus external to the signal processing apparatus.

11. The signal processing apparatus of claim 1, further comprising:
a compression/decompression unit configured to execute an arithmetic operation of lossless compression on the output data and an arithmetic operation of decompression on the first form data; and
a selection unit configured to select execution of either the arithmetic operation according to the compression layer and the restoration layer or the arithmetic operation of the lossless compression and the decompression by the compression/decompression unit,
wherein the processing unit performs an arithmetic operation on the output data and an arithmetic operation on the first form data according to the selection by the selection unit.

12. The signal processing apparatus of claim 11, wherein
in a case where a compression ratio by the compression/decompression unit and an amount of data of the output data satisfy a predetermined condition, the selection unit selects the arithmetic operation of the lossless compression and the decompression by the compression/decompression unit.

13. The signal processing apparatus of claim 12, wherein
a compression ratio of compression on the output data by the compression layer is higher than a compression ratio of compression on the output data by lossless compression.

14. The signal processing apparatus of claim 11, further comprising:
a measuring unit configured to measure an available memory bandwidth in the storage unit,
wherein the compression/decompression unit includes a plurality of compression/decompression units that perform an arithmetic operation with lossless compression of different compression ratios, and
the selection unit selects which compression/decompression unit to use based on the measured memory bandwidth.

15. The signal processing apparatus of claim 11, further comprising:
a compression ratio calculation unit configured to calculate a compression ratio of the output data from the available memory bandwidth in the storage unit and an amount of output data,
wherein the processing unit performs the arithmetic operation of the lossless compression and the decompression by the compression/decompression unit based on the calculated compression ratio.

16. The signal processing apparatus of claim 15, further comprising:
wherein the compression/decompression unit includes a plurality of compression/decompression units that perform an arithmetic operation with lossless compression of different compression ratios, and
wherein the selection unit selects which compression/decompression unit to use based on the calculated compression ratio.

17. The signal processing apparatus of claim 1, further comprising:
a determination unit configured to determine, for image data inputted to the processing unit, a degree of importance for each feature based on output data obtained by executing a convolution operation for extracting features related to predetermined characteristic components,
wherein the processing unit does not output, as the first form data, data related to the feature depending on the determined degree of importance.

18. The signal processing apparatus of claim 17, wherein
the processing unit changes whether the first form data stored in the storage unit is used depending on the determined degree of importance.

19. A method of controlling a signal processing apparatus, the method comprising:
executing a convolution operation of predetermined layers constituting a neural network; and
transferring first form data to be stored in a storage unit,
wherein in the executing,
an arithmetic operation of a compression layer that is configured by a neural network and compresses data is further executed on output data outputted from a convolution operation of a first layer among the predetermined layers, and the first form data to be transmitted to the storage unit is outputted, and
an arithmetic operation of a restoration layer that is configured by a neural network and restores pre-compression data is executed on the first form data stored in the storage unit, and input data to be inputted to a convolution operation of a second layer among the predetermined layers is outputted.

20. A non-transitory computer-readable storage medium comprising instructions for performing a method of controlling a signal processing apparatus, the method comprising:
executing a convolution operation of predetermined layers constituting a neural network; and
transferring first form data to be stored in a storage unit,
wherein in the executing,
an arithmetic operation of a compression layer that is configured by a neural network and compresses data is executed on output data outputted from a convolution operation of a first layer among the predetermined layers, and the first form data to be transmitted to the storage unit is outputted, and
an arithmetic operation of a restoration layer that is configured by a neural network and restores pre-compression data is executed on the first form data stored in the storage unit, and input data to be inputted to a convolution operation of a second layer among the predetermined layers is outputted.
